(19) United States
(12) Patent Application Publication
(10) Pub. No.: US 2026/0302570 A1
(43) Pub. Date: Oct. 1, 2026

(54) BATTERY CASE FOR SECONDARY BATTERY, SECONDARY BATTERY INCLUDING BATTERY CASE, AND METHOD OF MANUFACTURING SECONDARY BATTERY

(71) Applicant: SAMSUNG SDI CO., LTD., Yongin-si (KR)

(72) Inventor: Joonchul KIM, Yongin-si (KR)

(21) Appl. No.: 19/563,318

(22) Filed: Mar. 11, 2026

(30) Foreign Application Priority Data
Mar. 26, 2025 (KR) 10-2025-0038675

(51) Int. Cl. H01M 50/595; H01M 50/103; H01M 50/119; H01M 50/586

(52) U.S. Cl. CPC H01M 50/595; H01M 50/103; H01M 50/119; H01M 50/586

(57) ABSTRACT

A case for a secondary battery according to some embodiments of the present disclosure may include a lower case having an accommodation space to accommodate a portion of an electrode assembly, an upper case covering the open side of the accommodation space and sealing the opening, and a first insulator disposed on a portion of the inner surface of the sidewall portion of the lower case. The lower case may include a bottom portion, a sidewall portion having an inner surface and extending vertically from the bottom portion, and an opening at an open side of the accommodation space.

### CROSS-REFERENCE TO RELATED APPLICATION

The present application claims priority to and the benefit of Korean Application No. 10-2025-0038675, filed on Mar. 26, 2025, in the Korean Intellectual Property Office, the entire disclosure of which is incorporated by reference herein.

### BACKGROUND

### Field

The present disclosure relates to a case for a secondary battery, a secondary battery including the case, and a method of manufacturing the secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and are widely used for storing power (e.g., home and/or utility scale power storage). A secondary battery generally includes an electrode assembly composed of a positive electrode and a negative electrode, a case accommodating the electrode assembly, and electrode terminals connected to the electrode assembly.

When some known secondary batteries experience a strong external impact, the electrode assembly may separate from or be damaged inside the case. Upon such a separation from the case, an internal short circuit may occur because the electrode assembly contacts the case, which can lead to serious safety issues such as ignition or explosion. Secondary batteries for portable devices are more likely to be exposed to repetitive impacts and movement, so safety concerns are even more important. Moreover, because detachable secondary batteries are required for certain electronic products, a new secondary battery structure capable of replacing conventional batteries, while providing impact resistance and guaranteed safety, is needed.

The above information disclosed in this Background section is for enhancement of understanding of the background of the present disclosure, and therefore, it may contain information that does not constitute related (or prior) art.

### SUMMARY

The present disclosure provides a case for a secondary battery, a secondary battery including the case, and a method of manufacturing the secondary battery in order to resolve the above-described problems.

These and other aspects and features of the present disclosure will be described in or will be apparent from the following summary describing some embodiments of the present disclosure.

A case for a secondary battery according to some embodiments of the present disclosure may include a lower case having an accommodation space to accommodate a portion of an electrode assembly, an upper case covering the open side of the accommodation space and sealing the opening, and a first insulator disposed on a portion of the inner surface of the sidewall portion of the lower case. The lower case may include a bottom portion, a sidewall portion having an inner surface and extending vertically from the bottom portion, and an opening at an open side of the accommodation space.

In some embodiments, the sidewall portion of the lower case may include a curved portion having a curved geometry and an inner surface. The first insulator may be disposed on the inner surface of the curved portion.

In some embodiments, the sidewall portion of the lower case further may include a planar portion having a flat geometry and being connected to the curved portion. The first insulator may be disposed, on an inner surface of the planar portion, at a predetermined distance from a boundary between the curved portion and the planar portion.

In some embodiments, one surface of the sidewall portion of the lower case may have a through hole. The first insulator surrounds the through hole.

In some embodiments, the first insulator may be coated with an insulating solution.

In some embodiments, the insulating solution may include polyimide (PI), alumina, boehmite, ceramic, ethylene tetrafluoroethylene (ETFE), oxide, polychlorotrifluoroethylene (PCTFE), silicone, or halide-based perovskite.

In some embodiments, the first insulator may include an insulating tape.

In some embodiments, the insulating tape may include polyimide (PI), polyethylene terephthalate (PET), polytetrafluoroethylene (PTFE), polyvinyl chloride (PVC), or polypropylene (PP).

In some embodiments, the upper case may include an accommodation space to accommodate a portion of the electrode assembly, a ceiling portion, and a sidewall portion having an inner surface and extending vertically from the ceiling portion. The case further may include a second insulator disposed on a portion of the inner surface of the sidewall portion of the upper case.

In some embodiments, the lower case may include a metal including stainless use steel.

A secondary battery according to some embodiments of the present disclosure may include an electrode assembly and a case. The electrode assembly may include a first electrode, a second electrode, and a separator. The case may include a lower case having an accommodation space to accommodate a portion of the electrode assembly, an upper case covering the open side of the accommodation space and sealing the opening, and a first insulator disposed on a portion of the inner surface of the sidewall portion of the lower case. The lower case may include a bottom portion, a sidewall portion having an inner surface and extending vertically from the bottom portion, and an opening at an open side of the accommodation space.

In some embodiments, the sidewall portion of the lower case may include a curved portion having a curved geometry and an inner surface. The first insulator may be disposed on the inner surface of the curved portion.

In some embodiments, the sidewall portion of the lower case further may include a planar portion having a flat geometry and being connected to the curved portion. The first insulator may be disposed, on an inner surface of the planar portion, at a predetermined distance from a boundary between the curved portion and the planar portion.

In some embodiments, one surface of the sidewall portion of the lower case may have a through hole for insertion of an electrode terminal electrically connected to the first electrode. The first insulator surrounds the through hole.

In some embodiments, the first insulator may be coated with an insulating solution.

In some embodiments, the first insulator may include an insulating tape.

In some embodiments, the upper case may include an accommodation space to accommodate a portion of the electrode assembly, a ceiling portion, and a sidewall portion having an inner surface and extending vertically from the ceiling portion. The secondary battery further may include a second insulator disposed on a portion of the inner surface of the sidewall portion of the upper case.

In some embodiments, the lower case may include a metal including stainless use steel.

A method of manufacturing a secondary battery according to some embodiments of the present disclosure may include preparing an electrode assembly, preparing a case, disposing an insulator on a portion of the inner surface of the sidewall portion of a lower case; inserting the electrode assembly into an accommodation space of the lower case; and covering an open side of the lower case with an upper case to seal the opening thereof. The electrode assembly may include a first electrode a second electrode, and a separator interposed between the first electrode and the second electrode. The case may include the lower case and the upper case corresponding to the lower case. The lower case may include a bottom portion and a sidewall portion having an inner surface and extending vertically from the bottom portion. The lower case may have an opening at an open side of the lower case and may have an accommodation space to accommodate a portion of the electrode assembly.

In some embodiments, the method may further include configuring the sidewall portion of the lower case such that the sidewall portion may include a curved portion having a curved geometry and an inner surface. Disposing the insulator on a portion of the inner surface of the sidewall portion of the lower case may include disposing the insulator on the inner surface of the curved portion.

According to various embodiments of the present disclosure, the structure in which an insulator is disposed on an inner surface of at least one curved portion of the lower case may block direct contact between the electrode assembly and the conductive lower case, thereby reducing the risk of short circuit generation. Additionally, when the electrode assembly approaches the inner surface of the curved portion of the lower case due to an external impact or a drop, the insulator may prevent an electrical short circuit, enhancing the electrical insulation and physical stability of the secondary battery.

According to various embodiments of the present disclosure, the structure in which an insulator is disposed, on an inner surface of at least one planar portion of the lower case, at a predetermined distance from a boundary between a curved portion and the planar portion may optimize the internal space of the case and improve the energy density of the secondary battery. Moreover, upon an external impact or drop, the insulator may relieve stress concentration that can occur at the curved portion–planar portion boundary and may ensure physical stability.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate some embodiments of the present disclosure and further describe aspects and features of the present disclosure together with the detailed description of the present disclosure. The present disclosure should not be construed as being limited to the drawings:

FIG. 1 is an exploded perspective view illustrating a secondary battery according to some embodiments of the present disclosure.

FIG. 2A illustrates a secondary battery according to some embodiments of the present disclosure.

FIG. 2B shows a top plan view of a bottom portion of a case according to some embodiments of the present disclosure.

FIG. 2C is a perspective view illustrating a case according to some embodiments of the present disclosure.

FIG. 3 is a cross sectional view illustrating an insulator according to some embodiments of the present disclosure.

FIG. 4 is a perspective view of an attachment position of an insulating tape for a case according to some embodiments of the present disclosure.

FIG. 5 is a longitudinal cross-sectional view of a secondary battery showing an attachment position of an insulating tape according to some embodiments of the present disclosure.

FIG. 6 is a perspective view of a case showing an attachment position of an insulating tape according to some embodiments of the present disclosure.

FIG. 7 is an enlarged view of a case showing an attachment position of an insulating tape according to some embodiments of the present disclosure.

FIG. 8 is a perspective view of a case showing an attachment position of an insulating tape according to some embodiments of the present disclosure.

FIG. 9 is an exemplary flowchart illustrating a method of manufacturing a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements and/or layers may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” and “upper”, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements and/or features as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the scope of the disclosure.

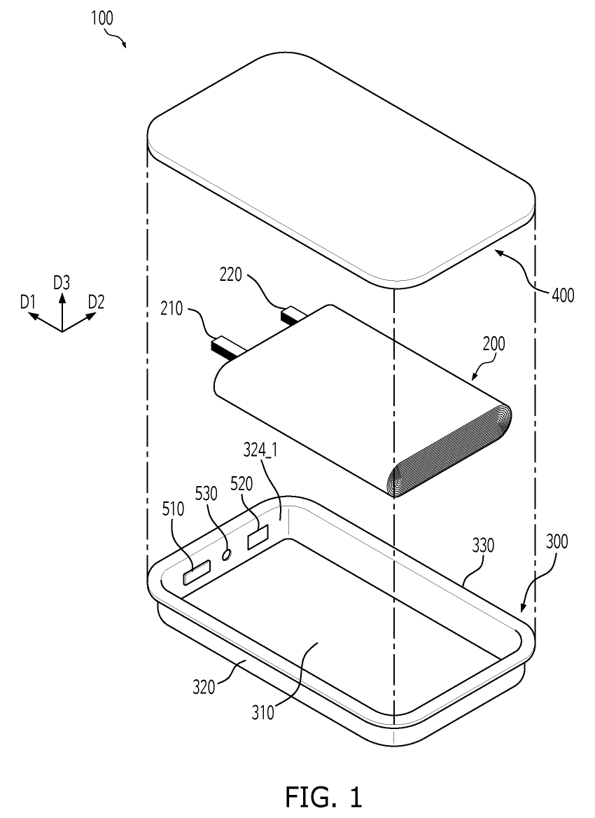

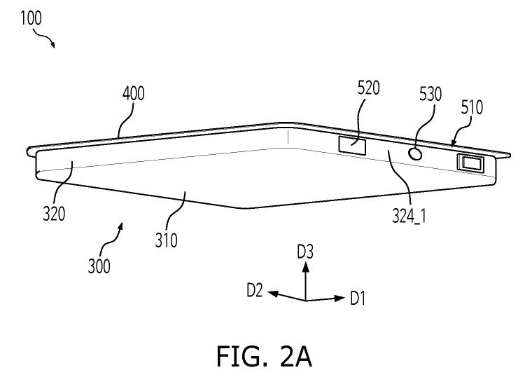

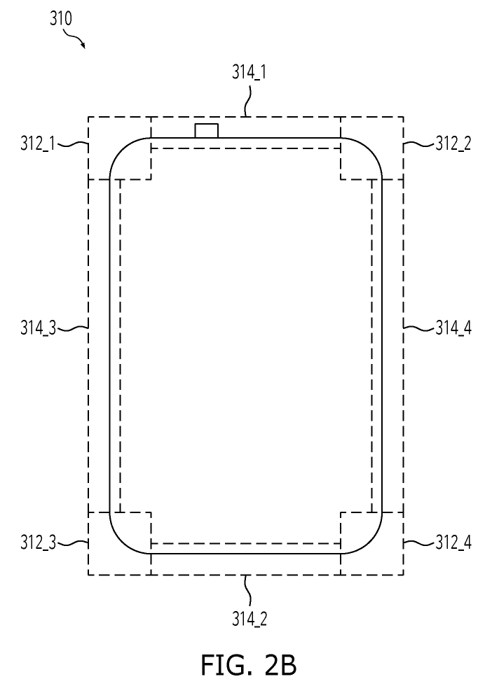

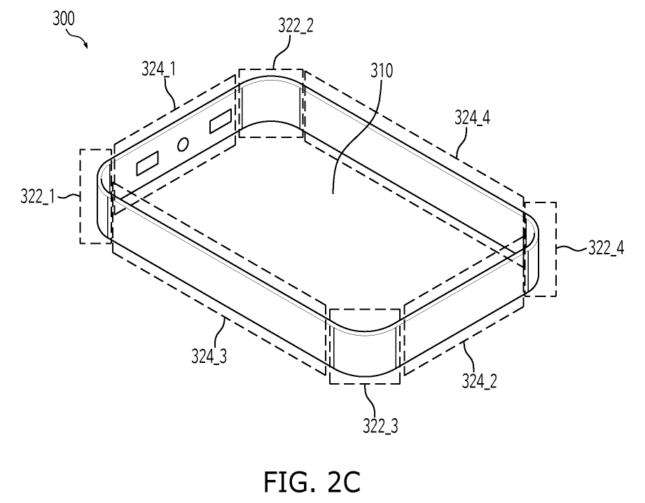

FIG. 1 is an exploded perspective view illustrating a secondary battery 100 according to some embodiments of the present disclosure. FIG. 2A illustrates the secondary battery 100 according to some embodiments of the present disclosure. FIG. 2B shows a top plan view of a bottom portion 310 of a case 300 according to some embodiments of the present disclosure. FIG. 2C is a perspective view illustrating the case 300 according to some embodiments of the present disclosure.

In some embodiments, the secondary battery 100 may include an electrode assembly 200 and a case 300, 400. The case 300, 400 may include a lower case 300, an upper case 400, a first electrode terminal 510, a second electrode terminal 520, and an electrolyte injection port 530.

In some embodiments, the electrode assembly 200 may include a first electrode, a second electrode, and a separator interposed between the first electrode and the second electrode. The first electrode may include an active material coated region, which is an active material layer formed on a thin metal foil current collector, and an uncoated region where the active material is not coated. The electrode assembly 200 may have a stack type structure in which first and second electrodes, each having a sheet geometry, are alternately stacked with the separator interposed between each first electrode and respective second electrode. However, the structure of the electrode assembly 200 is not limited thereto and may have a wound structure in which the first electrode, the separator, and the second electrode are sequentially wound.

In some embodiments, the electrode assembly 200 may include a first electrode tab 210 connected to the first electrode and a second electrode tab 220 connected to the second electrode. The first electrode tab 210 and the second electrode tab 220 may protrude from at least one surface of the electrode assembly 200.

In some embodiments, the lower case 300 may form an overall external appearance of the case. The lower case 300 may include an accommodation space in the lower case 300 to accommodate at least a portion of the electrode assembly 200. The lower case 300 may include the bottom portion 310, the sidewall portion 320 extending vertically from the bottom portion 310, and an opening at one side of the accommodation space. The lower case 300 may include the accommodation space capable of accommodating the electrode assembly 200 and a flange portion 330 formed along a perimeter of an opened surface. After the electrode assembly 200 is accommodated in the case, the flange portion 330 of the lower case 300 may be welded to the upper case 400 along the perimeter. However, the lower case 300 is not limited thereto and may have a structure in which at least one surface is opened or a structure including a folding type upper case 400 that covers the lower case 300 after the electrode assembly 200 is accommodated.

Although a structure having a flange on the lower case has been described above, the present disclosure is not limited to the above description of the lower case with a flange, and the lower case may instead be joined to a cover without the case having a flange.

Referring to FIG. 2B, the bottom portion 310 may have a rounded rectangle geometry. The rounded rectangle may include curved portions 312_1 to 312_4 having a predetermined curvature and straight portions 314_1 to 314_4 connecting adjacent curved portions 312_1 to 312_4. The curved portions 312_1 to 312_4 may be formed to disperse stress that can concentrate on corners of the case and to protect the electrode assembly 200 of the secondary battery 100 from external impact or vibration. The straight portions 314_1 to 314_4 may maintain flatness of the bottom portion and to efficiently utilize the internal space of the secondary battery 100.

In some embodiments, the sidewall portion 320 of the lower case 300 may include at least one curved portion 322_1 to 322_4. Referring to FIG. 2C, the curved portions 322_1 to 322_4 may vertically extend from the curved portions 312_1 to 312_4 of the bottom portion. The curved portions 322_1 to 322_4 may have a curved geometry with a predetermined radius of curvature. In some embodiments, the curved portions 322_1 to 322_4 may include a curved geometry having a single predetermined radius of curvature. Through such a configuration, the curved portions 322_1 to 322_4 may provide a structure in which an overall consistent curvature is maintained, so that external impact or stress distribution is effectively dispersed and durability of the secondary battery can be reinforced. However, the geometry of the curved portions 322_1 to 322_4 is not limited thereto and may be designed according to various structural requirements. In some embodiments, the curved portions 322_1 to 322_4 may include a curved geometry having a plurality of predetermined radii of curvature.

In some embodiments, the sidewall portion 320 of the lower case 300 may include at least one planar portion 324_1 to 324_4. The planar portions 324_1 to 324_4 may have a flat geometry connecting adjacent curved portions 322_1 to 322_4. The planar portions 324_1 to 324_4 may vertically extend from the straight portions 314_1 to 314_4 of the bottom portion. Through such a configuration, the planar portions 324_1 to 324_4 may provide a balanced outer appearance of the entire case and may facilitate a manufacturing process of the secondary battery 100.

In some embodiments, the lower case 300 may include a conductive material. In some embodiments, the lower case 300 may be made of a metal including stainless steel (SUS). In some embodiments, the lower case 300 may include a conductive metal such as aluminum, an aluminum alloy, or nickel-plated steel. The thickness of the lower case 300 may be 0.05 mm to 0.3 mm, but the thickness of the lower case 300 is not limited thereto.

In some embodiments, an electrolyte injection port 530 may be formed on a first surface of the lower case 300. An insulator and a terminal plate may be disposed on an inner surface of the first surface of the lower case 300. The first electrode terminal 510 and/or the second electrode terminal 520 may be disposed on an outer surface of the first surface of the lower case 300.

In some embodiments, the upper case 400 may cover the open side of the accommodation space of the lower case 300 and may seal the opening. The upper case 400 may have a flat planar geometry. Through such a configuration, the secondary battery 100 including the planar upper case 400 may provide a simple and stable structure. However, a geometry of the upper case 400 is not limited thereto and may be variously designed according to a geometry of the electrode assembly 200 and specifications of the secondary battery 100.

In some embodiments, an upper accommodation space capable of accommodating at least a portion of the electrode assembly 200 may be formed in the upper case 400. The upper case 400 may include a ceiling portion, an upper sidewall portion extending vertically from the ceiling portion, and/or an upper opening at one side of the upper accommodation space. Through such a configuration, the electrode assembly 200 may be stably fixed because the electrode assembly 200 is accommodated in both the accommodation space formed in the lower case 300 and the upper accommodation space formed in the upper case 400, and a desired capacity of the secondary battery may be achieved.

In some embodiments, the upper case 400 may include the upper accommodation space capable of accommodating at least part of the electrode assembly 200 and an upper flange portion formed along a perimeter of the upper opening. The upper flange portion may function as a main joint portion when the lower case 300 and the upper case 400 are combined. In some embodiments, after the electrode assembly 200 is accommodated in the case, the upper flange portion of the upper case 400 may be designed to precisely engage the flange portion 330 of the lower case 300.

In some embodiments, an insulator may include a first insulator disposed on at least a portion of an inner surface of the sidewall portion 320 of the lower case 300. The insulator may further include a second insulator disposed on at least a portion of an inner surface of the upper sidewall portion of the upper case 400 including the upper accommodation space.

In some embodiments, the insulator may include a portion coated with an insulating solution. The insulating solution may include at least one selected from the group consisting of polyimide (PI), alumina, boehmite, ceramic, ethylene tetrafluoroethylene (ETFE), oxide, polychlorotrifluoroethylene (PCTFE), silicone, and halide-based perovskite.

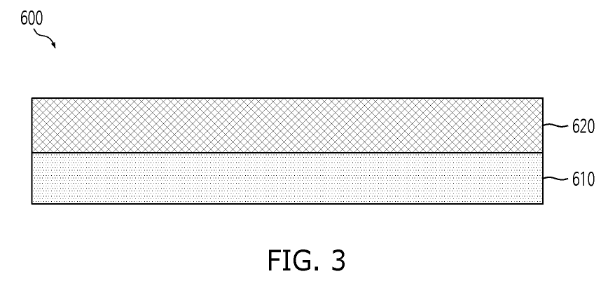

In some embodiments, the insulator may include an insulating tape. The insulating tape may include at least one selected from the group consisting of polyimide (PI), polyethylene terephthalate (PET), polytetrafluoroethylene (PTFE), polyvinyl chloride (PVC), and polypropylene (PP). A detailed description of the insulator including the insulating tape will be given below with reference to FIG. 3.

In some embodiments, the first electrode terminal 510 may be disposed on an outer surface of the first surface of the lower case 300. A through hole may be formed in one surface (for example, a first planar portion 324_1) of the sidewall portion 320 of the lower case 300. The first electrode terminal 510 may be formed on the first through hole of the lower case 300. The first electrode terminal 510 may be insulated from the lower case 300. A gasket (not shown) may be interposed between the first electrode terminal 510 and the lower case 300, so that the first electrode terminal 510 and the lower case 300 are insulated from each other.

In some embodiments, the second electrode terminal 520 may be disposed on the outer surface of the first surface of the lower case 300. The second electrode terminal 520 may be in contact with the lower case 300. Because the lower case may be subject to welding damage during a process of welding the lower case to external components, the second electrode terminal 520 having high rigidity against welding may be attached to the outer surface of the lower case 300.

In some embodiments, the electrolyte injection port 530 may be formed between the first electrode terminal 510 and the second electrode terminal 520. However, the position of the electrolyte injection port 530 is not limited thereto and may be formed in any region of the first surface of the lower case 300 or in another surface. After an electrolyte is injected, the electrolyte injection port 530 may be sealed by a sealer (not shown).

FIG. 3 is a cross sectional view illustrating an insulator according to some embodiments of the present disclosure.

In some embodiments, an insulator 600 may include an insulating tape. Referring to FIG. 3, the insulator may include a first adhesive layer 610 and a second adhesive layer 620. Some descriptions of FIG. 3 that overlap with those of FIGS. 1-2C may be omitted.

In some embodiments, the insulator 600 may be configured as a single adhesive layer including one adhesive layer. Such an insulator 600 may have a simple structure, may be easy to manufacture, and may simplify a manufacturing process of the secondary battery. However, the structure of the insulator 600 is not limited thereto, and the structure of the insulator 600 may include two or more multilayer adhesive layers according to characteristics of the electrode assembly and specifications of the secondary battery.

In some embodiments, the first adhesive layer 610 of the insulator 600 may be attached to and/or in contact with at least a portion of an inner surface of the case. The first adhesive layer 610 may be designed to directly contact the inner surface of the case made of a metal material. The first adhesive layer 610 may be made of a material that maintains adhesion to the metal surface and has heat and chemical resistance. For example, the first adhesive layer 610 may include epoxy, silicone adhesive, polyurethane, or acrylic adhesive.

In some embodiments, the second adhesive layer 620 of the insulator 600 may contact an outer surface of the electrode assembly. The second adhesive layer 620 may contact an outer surface of the electrode assembly made of an insulating material such as a polymer. To reinforce adhesion to the electrode assembly and minimize effects of drop, impact, or vibration on the electrode assembly, the second adhesive layer 620 may be made of a polymer adhesive material having flexibility and elasticity. For example, the second adhesive layer 620 may include polyimide (PI), polytetrafluoroethylene (PTFE), polypropylene (PP), or ethylene propylene rubber (EPDM). Through such a configuration, stability of the secondary battery can be enhanced.

In some embodiments, the second adhesive layer 620 may face the electrode assembly accommodated in the case. In the process of inserting the electrode assembly into the case, the electrode assembly may contact the second adhesive layer 620, but the electrode assembly is not limited thereto. In some embodiments, without contacting the second adhesive layer 620 during an insertion process of the electrode assembly into the case, the electrode assembly may contact the second adhesive layer 620 when the electrode assembly expands during charge and discharge of the secondary battery.

In some embodiments, the second adhesive layer 620 of the tape may exhibit adhesiveness during an activation stage of the secondary battery. After the electrode assembly inserted into the lower case is sealed after electrolyte injection, the secondary battery may undergo an activation stage in which the secondary battery is charged/discharged or aged at a high temperature (e.g., 60 °C. to 90 °C.), and the adhesive property of the second adhesive layer 620 may be manifested. Before the activation stage, only the first adhesive layer 610 of the tape has adhesiveness, and after the activation stage, both the first adhesive layer 610 and the second adhesive layer 620 of the tape may have adhesiveness.

Through such a configuration, the electrode assembly of the secondary battery after the activation stage may be fixed so as not to move inside the case. In addition, before the activation stage of the secondary battery, because the adhesive property of the second adhesive layer 620 facing the electrode assembly is not manifested, sufficient time for impregnation of electrolyte into the electrode assembly may be achieved.

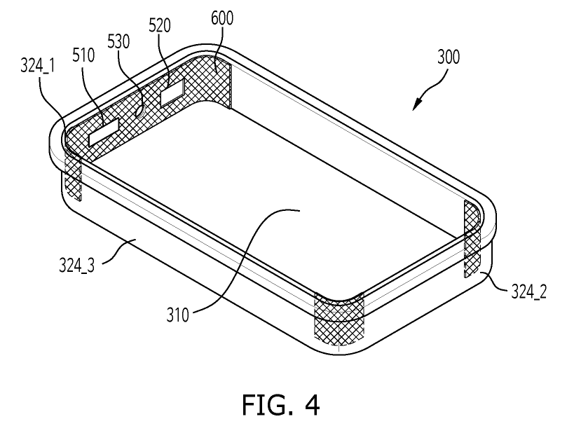

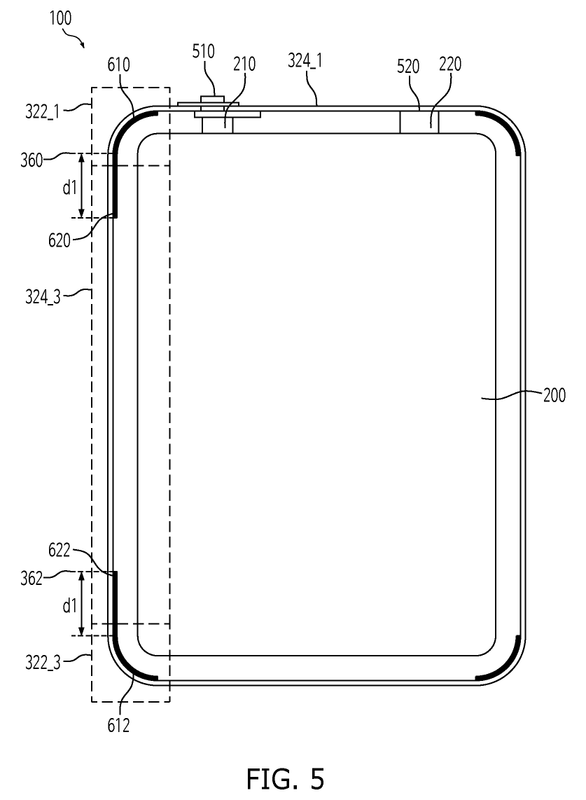

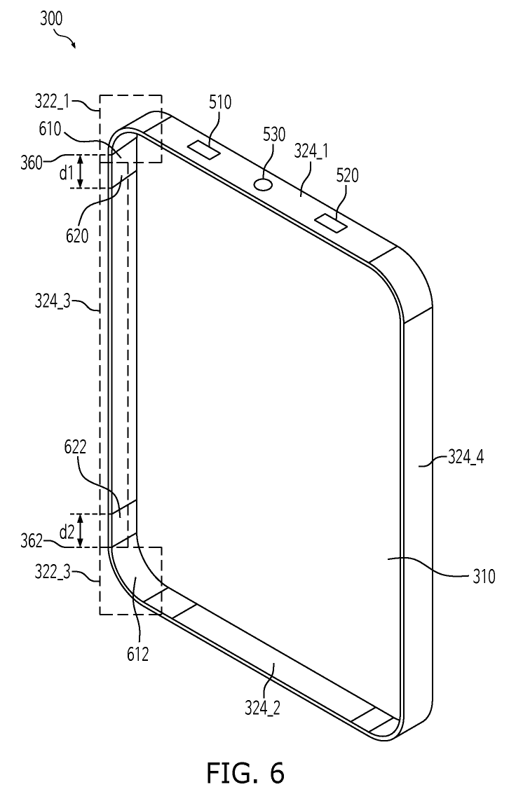

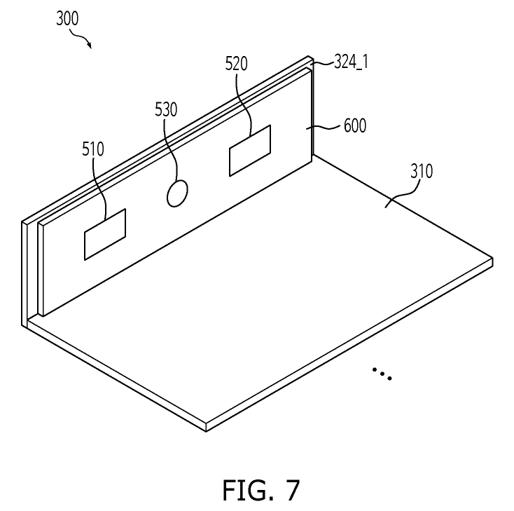

FIG. 4 is a perspective view of a case for explaining an attachment position of an insulating tape according to some embodiments of the present disclosure. FIG. 5 is a longitudinal cross-sectional view of a secondary battery showing an attachment position of an insulating tape according to some embodiments of the present disclosure. FIG. 6 is a perspective view of a case showing an attachment position of an insulating tape according to some embodiments of the present disclosure. FIG. 7 is an enlarged view of a case showing an attachment position of an insulating tape according to some embodiments of the present disclosure. Some descriptions of FIGS. 4-7 that overlap with those of FIGS. 1-3 may be omitted.

Referring to FIG. 4, the lower case 300 may include the bottom portion 310 and the sidewall portion extending vertically from the bottom portion 310, and an opening may be formed at one end of the sidewall portion.

In some embodiments, the bottom portion 310 may have a rounded rectangle geometry. The rounded rectangle may include curved portions having a predetermined curvature and straight portions connecting the curved portions. The curved portions may disperse stress that can concentrate on corners of the case and to protect the electrode assembly of the secondary battery from external impact or vibration. The straight portions may maintain flatness of the bottom portion 310 and to efficiently utilize the internal space of the secondary battery.

In some embodiments, the sidewall portion may include at least one curved portion (for example, 322_1, 322_3). The curved portions 322_1, 322_3 may have a curved geometry with a predetermined radius of curvature. The curved portions 322_1, 322_3 may vertically extend from the curved portions of the bottom portion 310.

In some embodiments, the insulator 600 may be disposed on an inner surface of at least one curved portion 322_1, 322_3 of the lower case 300. The insulator 600 may block direct contact between the electrode assembly and the conductive lower case 300, thereby reducing the risk of a short circuit generation. When the electrode assembly approaches the inner surface of the curved portion 322_1, 322_3 of the lower case 300 due to an external impact or drop, the insulator 600 may prevent an electrical short circuit, thereby improving electrical insulation and physical stability of the secondary battery.

In some embodiments, the sidewall portion may include at least one planar portion 324_1 to 324_4. The planar portions 324_1 to 324_4 may have a flat geometry connecting at least one curved portion 322_1, 322_3. The planar portions 324_1 to 324_4 may vertically extend from the straight portions of the bottom portion 310.

In some embodiments, the insulator 600 may be disposed on an inner surface of at least one planar portion of the lower case 300. Referring to FIG. 4, the insulator 600 may be disposed on both the curved portions and the planar portion 324_1 in which through holes of the first electrode terminal, the second electrode terminal, and the electrolyte injection port 510, 520, 530 are formed. The insulator 600 may be disposed around (or may surround) the through holes of the first electrode terminal, the second electrode terminal, and the electrolyte injection port 510, 520, 530 of the planar portion 324_1. Through such a configuration, the insulator 600 may not only disperse external impact applied to the secondary battery but also appropriately insulate around the electrode terminals and/or electrolyte injection port, thereby improving physical, chemical stability, and durability of the secondary battery.

Referring to FIGS. 5 and 6, the insulator 600 may include insulators 620, 622 disposed, on an inner surface of at least one planar portion (for example, 324_3) of the lower case 300, at predetermined distances d1, d2 from boundaries 360, 362 between the curved portion and the planar portion. The predetermined distances d1, d2 may be set identical to or different from each other. The insulators 620, 622 may be additionally or selectively disposed at required positions to optimize the internal space of the case and to improve an energy density of the secondary battery. In addition, the insulators 620, 622 may relieve a concentration of stress that may form at the boundaries 360, 362 between the curved portion and the planar portion upon external impact or drop, the insulators 620, 622 may ensure physical stability of the secondary battery, the insulators 620, 622 may reduce the risk of internal short circuit generation of the secondary battery, and the insulators 620, 622 may provide electrical stability of the secondary battery.

Referring to FIG. 6, the electrode assembly may be inserted into the lower case 300. The electrode assembly may be a stack type electrode assembly in which a first electrode, a separator, and a second electrode are stacked. Alternatively, the electrode assembly may be a wound type electrode assembly in which the first electrode, the separator, and the second electrode are wound.

In some embodiments, at least one electrode tab may protrude from at least one surface of the electrode assembly. Electrode tabs connected to the respective first and second electrodes may protrude from at least one surface of the electrode assembly.

Referring to FIG. 7, a through hole may be formed in one surface of the sidewall portion (for example, the first planar portion 324_1) of the lower case 300. At least one through hole (such as a through hole of the first electrode terminal, the second electrode terminal, and the electrolyte injection port 510, 520, 530) may be formed in the first planar portion 324_1 among the first to fourth planar portions of the sidewall portion. Electrode terminals electrically connected to the electrode assembly may be inserted into one or both of the through holes of the first electrode terminal and the second electrode terminal 510, 520. In addition, the remaining through hole 530 may function as the electrolyte injection port.

In some embodiments, the insulator 600 may be disposed around the through holes of the first electrode terminal, the second electrode terminal, and the electrolyte injection port 510, 520, 530. In some embodiments, with the electrode assembly accommodated in the lower case 300, the insulator may be disposed around the through holes in the sidewall portion (for example, the first planar portion 324_1) of the lower case 300 facing the surface of the electrode assembly from which the electrode tabs protrude. In some embodiments, the insulator 600 may be disposed around the electrode terminals 510, 520 and/or electrolyte injection port 530 associated with the through holes. The insulator 600 may stably protect a portion where the electrode assembly and the electrode terminals are electrically connected and may perform additional functions. In some embodiments, the insulator 600 may be designed as a multilayer structure or a foam layer structure and may be disposed to relieve impacts and vibrations around the electrode terminals. In some embodiments, the insulator 600 may include a material having high thermal conductivity and may be dissipate heat around the electrode terminals 510, 520, thereby preventing overheating of the secondary battery and controlling an internal temperature. In some embodiments, the insulator 600 may be designed as a dual seal structure or a sealing structure with a ring geometry and may block inflow of electrolyte around the electrode terminals and may prevent corrosion and a short circuit caused by leakage of electrolyte inside the battery.

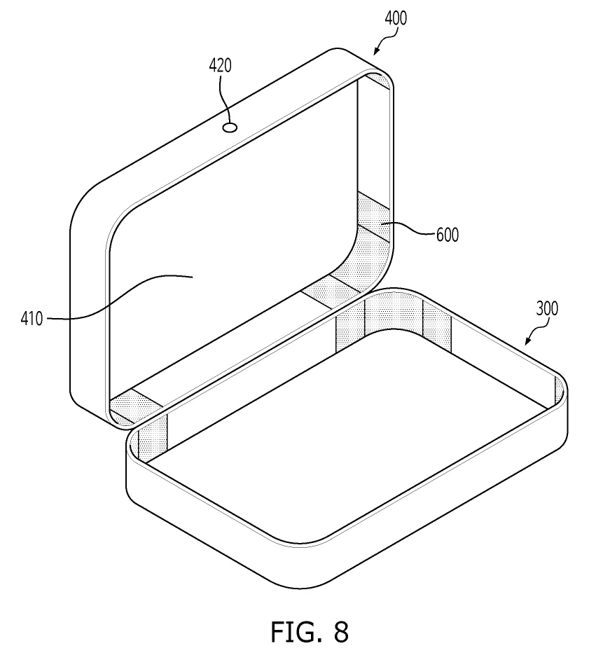

FIG. 8 is a perspective view of a case showing an attachment position of an insulating tape according to some embodiments of the present disclosure. Some descriptions of FIG. 8 that overlap with those of FIGS. 1-7 may be omitted.

Referring to FIG. 8, the case may include the lower case 300 and the upper case 400. The lower case 300 and the upper case 400 may cooperatively accommodate the electrode assembly. A first accommodation space (or lower accommodation space) capable of accommodating a portion of the electrode assembly may be formed in the lower case 300, and a second accommodation space (or upper accommodation space) capable of accommodating a remaining portion of the electrode assembly may be formed in the upper case 400.

In some embodiments, the upper case 400 may include a ceiling portion 410 and an upper sidewall portion 420 extending vertically from the ceiling portion 410, and an upper opening may be formed at one end of the upper sidewall portion 420. The ceiling portion 410, the upper sidewall portion 420, and the upper opening of the upper case 400 may respectively correspond to the bottom portion, the sidewall portion, and the opening of the lower case 300.

In some embodiments, the ceiling portion 410 may have a rounded rectangle geometry. The ceiling portion 410 may include curved portions having a predetermined curvature and straight portions connecting the curved portions.

In some embodiments, the upper sidewall portion 420 may include at least one curved portion and at least one planar portion. The curved portion may have a curved geometry with a predetermined radius of curvature. The planar portion may have a flat geometry connecting at least one curved portion.

In some embodiments, the insulator 600 may be disposed on an inner surface of at least one curved portion of the upper case 400. The insulator 600 may be disposed, on an inner surface of at least one curved portion of the upper case 400, at a predetermined distance from a boundary between the curved portion and a planar portion.

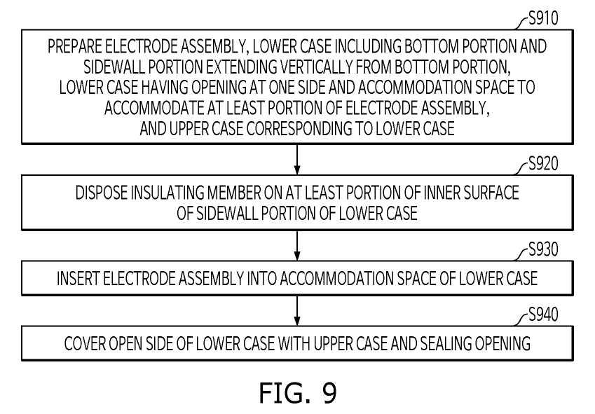

FIG. 9 is an exemplary flowchart illustrating a method 900 of manufacturing a secondary battery according to some embodiments of the present disclosure. Some descriptions of FIG. 9 that overlap with those of FIGS. 1-8 may be omitted.

In some embodiments, the method 900 of manufacturing a secondary battery may start, as operation S910, by preparing an electrode assembly including a first electrode, a second electrode, and a separator interposed between the first electrode and the second electrode; a lower case having a bottom portion and a sidewall portion extending vertically from the bottom portion, having an opening at one side, and having an accommodation space to accommodate at least a portion of the electrode assembly; and an upper case corresponding to the lower case. The sidewall portion of the lower case may include at least one curved portion having a curved geometry with a predetermined radius of curvature. In addition, the sidewall portion may include a planar portion having a flat geometry connecting at least one curved portion.

As operation S920, an insulator may be disposed on at least a portion of an inner surface of the sidewall portion of the lower case. In some embodiments, operation S920 may include disposing the insulator on an inner surface of at least one curved portion of the lower case. Operation S920 may further include disposing the insulator, on an inner surface of at least one planar portion of the lower case, at a predetermined distance from a boundary between the curved portion and the planar portion.

In some embodiments, operation S920 may include coating an insulating solution on at least a portion of the inner surface of the sidewall portion of the lower case. Operation S920 may include spraying an insulating solution on at least a portion of the inner surface of the sidewall portion and drying the sprayed insulating solution. The insulating solution may include polyimide (PI), alumina, boehmite, ceramic, ethylene tetrafluoroethylene (ETFE), oxide, polychlorotrifluoroethylene (PCTFE), silicone, and/or halide-based perovskite.

In some embodiments, operation S920 may include attaching an insulating tape to at least a portion of the inner surface of the sidewall portion of the lower case. The insulating tape may include polyimide (PI), polyethylene terephthalate (PET), polytetrafluoroethylene (PTFE), polyvinyl chloride (PVC), and/or polypropylene (PP).

As operation S930, the electrode assembly may be inserted into the accommodation space of the lower case. The electrode assembly may be precisely aligned inside the lower case such that the electrode assembly is stably fixed in the accommodation space. In addition, the first electrode tab and the second electrode tab of the electrode assembly may be electrically connected, respectively, to the first electrode terminal and the second electrode terminal formed in the sidewall portion of the lower case through welding.

As operation S940, the upper case may cover the open side of the lower case and the opening may be sealed. The upper case may be designed to precisely engage the lower case. In addition, the case may be sealed by laser welding at flange portions of the upper case and the lower case.

Although the present disclosure has been described above with respect to some embodiments thereof, the present disclosure is not limited thereto. Various modifications and variations can be made to the above-described embodiments by those skilled in the art.

### DESCRIPTION OF REPRESENTATIVE REFERENCE SYMBOLS

100: secondary battery

200: electrode assembly

210: first electrode tab

220: second electrode tab

300: lower case

310: bottom portion

320: sidewall portion

330: flange portion

400: upper case

600: insulator

What is claimed is:

1. A case for a secondary battery, the case comprising:
a lower case having an accommodation space to accommodate a portion of an electrode assembly, the lower case comprising:
a bottom portion;
a sidewall portion having an inner surface and extending vertically from the bottom portion; and
an opening at an open side of the accommodation space;
an upper case covering the open side of the accommodation space and sealing the opening; and
a first insulator disposed on a portion of the inner surface of the sidewall portion of the lower case.

2. The case as claimed in claim 1, wherein the sidewall portion of the lower case comprises a curved portion having a curved geometry and an inner surface, and
wherein the first insulator is disposed on the inner surface of the curved portion.

3. The case as claimed in claim 2, wherein the sidewall portion of the lower case further comprises a planar portion having a flat geometry and being connected to the curved portion, and
wherein the first insulator is disposed, on an inner surface of the planar portion, at a predetermined distance from a boundary between the curved portion and the planar portion.

4. The case as claimed in claim 1, wherein one surface of the sidewall portion of the lower case has a through hole, and
wherein the first insulator surrounds the through hole.

5. The case as claimed in claim 1, wherein the first insulator is coated with an insulating solution.

6. The case as claimed in claim 5, wherein the insulating solution comprises polyimide (PI), alumina, boehmite, ceramic, ethylene tetrafluoroethylene (ETFE), oxide, polychlorotrifluoroethylene (PCTFE), silicone, or halide-based perovskite.

7. The case as claimed in claim 1, wherein the first insulator comprises an insulating tape.

8. The case as claimed in claim 7, wherein the insulating tape comprises polyimide (PI), polyethylene terephthalate (PET), polytetrafluoroethylene (PTFE), polyvinyl chloride (PVC), or polypropylene (PP).

9. The case as claimed in claim 1, wherein the upper case comprises:
an accommodation space to accommodate a portion of the electrode assembly;
a ceiling portion; and
a sidewall portion having an inner surface and extending vertically from the ceiling portion, and
wherein the case further comprises a second insulator disposed on a portion of the inner surface of the sidewall portion of the upper case.

10. The case as claimed in claim 1, wherein the lower case comprises a metal comprising stainless use steel.

11. A secondary battery comprising:
an electrode assembly comprising:
a first electrode;
a second electrode; and
a separator; and
a case comprising:
a lower case having an accommodation space to accommodate a portion of the electrode assembly, the lower case comprising:
a bottom portion;
a sidewall portion having an inner surface and extending vertically from the bottom portion; and
an opening at an open side of the accommodation space;
an upper case covering the open side of the accommodation space and sealing the opening; and
a first insulator disposed on a portion of the inner surface of the sidewall portion of the lower case.

12. The secondary battery as claimed in claim 11, wherein the sidewall portion of the lower case comprises a curved portion having a curved geometry and an inner surface, and
wherein the first insulator is disposed on the inner surface of the curved portion.

13. The secondary battery as claimed in claim 12, wherein the sidewall portion of the lower case further comprises a planar portion having a flat geometry and being connected to the curved portion, and
wherein the first insulator is disposed, on an inner surface of the planar portion, at a predetermined distance from a boundary between the curved portion and the planar portion.

14. The secondary battery as claimed in claim 11, wherein one surface of the sidewall portion of the lower case has a through hole for insertion of an electrode terminal electrically connected to the first electrode, and
wherein the first insulator surrounds the through hole.

15. The secondary battery as claimed in claim 11, wherein the first insulator is coated with an insulating solution.

16. The secondary battery as claimed in claim 11, wherein the first insulator comprises an insulating tape.

17. The secondary battery as claimed in claim 11, wherein the upper case comprises:
an accommodation space to accommodate a portion of the electrode assembly;
a ceiling portion; and
a sidewall portion having an inner surface and extending vertically from the ceiling portion, and
wherein the secondary battery further comprises a second insulator disposed on a portion of the inner surface of the sidewall portion of the upper case.

18. The secondary battery as claimed in claim 11, wherein the lower case comprises a metal comprising stainless use steel.

19. A method of manufacturing a secondary battery, the method comprising:
preparing an electrode assembly comprising:
a first electrode;
a second electrode; and
a separator interposed between the first electrode and the second electrode,
preparing a case comprising:
a lower case comprising:
a bottom portion; and
a sidewall portion having an inner surface and extending vertically from the bottom portion,
wherein the lower case has an opening at an open side of the lower case and has an accommodation space to accommodate a portion of the electrode assembly; and
an upper case corresponding to the lower case;
disposing an insulator on a portion of the inner surface of the sidewall portion of the lower case;
inserting the electrode assembly into the accommodation space of the lower case; and
covering the open side of the lower case with the upper case to seal the opening.

20. The method as claimed in claim 19, further comprising:
configuring the sidewall portion of the lower case such that the sidewall portion comprises a curved portion having a curved geometry and an inner surface,
wherein disposing the insulator on a portion of the inner surface of the sidewall portion of the lower case comprises disposing the insulator on the inner surface of the curved portion.
